(19) United States
(12) Patent Application Publication
(10) Pub. No.: US 2024/0411524 A1
(43) Pub. Date: Dec. 12, 2024

(54) SYSTEM DESIGN DEVICE, SYSTEM DESIGN METHOD, AND NON-TRANSITORY STORAGE MEDIUM

(71) Applicant: NEC Corporation, Tokyo (JP)

(72) Inventors: Kazuki TANABE, Tokyo (JP); Takayuki KURODA, Tokyo (JP)

(73) Assignee: NEC Corporation, Tokyo (JP)

(21) Appl. No.: 18/732,722

(22) Filed: Jun. 4, 2024

(30) Foreign Application Priority Data
Jun. 12, 2023 (JP) 2023-096358

(51) Int. Cl. G06F 8/20

(52) U.S. Cl. CPC G06F 8/20

(57) ABSTRACT

A system design device generates, by repeatedly applying to requirements a concretization means that converts an abstract component included in the system into a concrete configuration with respect to the requirements of the system, a tree structure based on a configuration plan of the system, performs a search by selecting the configuration plan with a higher evaluation value in the tree structure generated, outputs the configuration plan in which all components are concretized as a concrete configuration; and calculates an evaluation value of the configuration plan by considering an evaluation value of a logical configuration plan of the system, and an evaluation value of a physical configuration plan of a device requiring physical arrangement included in the configuration plan.

This application is based upon and claims the benefit of priority from Japanese patent application No. 2023-096358, filed Jun. 12, 2023, the disclose of which is incorporated herein in its entirety by reference.

### TECHNICAL FIELD

The present disclosure relates to a system design device, a system design method, and a non-transitory storage medium.

### BACKGROUND ART

The process of constructing ICT (Information Communication Technology) systems involves a design phase to develop concrete system configurations that fulfill the required system requirements. During the design phase, it is necessary that after designing the configuration information of logical components such as applications, OS (Operation System), and networks meeting the requirements (referred to herein as logical configuration), the spatial configuration information of devices included in the logical configuration, such as servers, network equipment, and wireless terminals are determined, and concrete configuration including the logical configuration and the spatial configuration information of the devices is created. While there have been discussions regarding techniques aimed at automating the design of such systems, full automation of all processes has not yet been achieved. It should be noted that in this specification, logical configuration will refer to the logical configuration information of the system, and physical configuration will refer to the configuration information of the spatial arrangement of devices.

Patent Document 1 (Japanese Patent Publication No. 6989014) discloses a design automation technique for ICT systems using machine learning (learning-based system design automation technique) aimed at reducing the workload associated with designing ICT systems. In this technique, in generating concrete system configuration information from abstract system configuration information (requirements), a reward value is given to each generated system configuration plan (hereinafter referred to as configuration plan) and to each concretization means applied during the generation process, and artificial intelligence (AI) performs machine learning on the quality of the system configuration and the concretization means. As a result, AI can pseudo-acquire engineers' knowledge pertaining to system design (design knowledge), enabling the rapid and reliable system configuration design through learning in design and reward values for various requirements. Furthermore, the design automation technology disclosed in Non-Patent Document 1 (Takayuki KURODA, Yutaka YAKUWA, Kazuki TANABE, “Network Design Automation Technology Using Machine Learning”, The journal of the Institute of Electronics, Information and Communication Engineers, Vol. 105, No. 10, pp. 1208-1214 October 2022) enhances the learning-based system design automation technique outlined in Patent Document 1. This technique allows for the assessment of the quality of configuration plans in terms of both functional and performance aspects by calculating the evaluation values of configuration plans to be designed based on quantitative values indicating the extent to which designed configuration plans meet functional requirements (hereinafter referred to as likelihood) and the expected values of quantitative values associated with multiple quantitative requirements including delay, bandwidth, and cost. However, in the design automation techniques disclosed in Patent Document 1 and Non-Patent Document 1, while it is possible to generate the logical configuration of ICT systems, manual adjustments are necessary for the physical configuration. Thus, the complete automation of system configuration design, which includes the spatial arrangement of physical devices such as servers, network equipment, and wireless terminals, has not been achieved.

Patent Document 2 (Japanese Unexamined Patent Application First Publication No. 2021-136692) discloses a network design support device aimed at reducing the setup time for network systems to meet communication requirements. This device designs a logical network configuration (referred to as logical network) to meet the abstract requirements of a network. It also allocates resources to nodes in an existing physical network configuration (referred to as physical network) and designs communication paths. Introducing this device enables a reduction in the length of time required for designing and constructing logical networks. However, the technique disclosed in Patent Document 2 assumes that the physical network has been pre-designed and constructed, necessitating manual intervention for tasks such as determining the arrangement of newly introduced devices or modifying the arrangement of existing devices and the wiring between them. Consequently, the design phase, encompassing both physical and logical network aspects, is not entirely automated.

### SUMMARY

Therefore, one example of the purpose of the present disclosure is to provide a system design device, a system design method, and a non-transitory storage medium.

According to an example of one aspect of the present disclosure, provided is a system design device that receives requirements of a system as input and outputs a concrete configuration of the system, the system design device including: at least one memory configured to store instructions; and at least one processor configured to execute the instructions to: generate, by repeatedly applying to the requirements a concretization means that converts an abstract component included in the system into a concrete configuration, a tree structure in which the requirements serve as a root node and a configuration plan of the system concretizing the abstract component serves as a leaf node, perform a search by selecting the configuration plan with a higher evaluation value in the tree structure generated, and output the configuration plan in which all components are concretized as a concrete configuration; and calculate an evaluation value of the configuration plan by considering an evaluation value of a logical configuration plan of the system included in the configuration plan that makes up the tree structure, and an evaluation value of a physical configuration plan of a device requiring physical arrangement included in the configuration plan.

According to an example of one aspect of the present disclosure, provided is a system design method for receiving requirements of a system as input and outputting a concrete configuration of the system, the system design method including: generating, by repeatedly applying to the requirements a concretization means that converts an abstract component included in the system into a concrete configuration, a tree structure in which the requirements serve as a root node and a configuration plan of the system concretizing the abstract component serves as a leaf node; performing a search by selecting the configuration plan with a higher evaluation value in the tree structure generated; and outputting the configuration plan in which all components are concretized as a concrete configuration, wherein in the outputting, an evaluation value of the configuration plan is calculated by considering an evaluation value of a logical configuration plan of the system included in the configuration plan that makes up the tree structure, and an evaluation value of a physical configuration plan of a device requiring physical arrangement included in the configuration plan.

According to an example of one aspect of the present disclosure, a non-transitory storage medium that stores a program causes a computer to execute processes for a system design method for receiving requirements of a system as input and outputting a concrete configuration of the system, the processes including: generating, by repeatedly applying to the requirements a concretization means that converts an abstract component included in the system into a concrete configuration, a tree structure in which the requirements serve as a root node and a configuration plan of the system concretizing the abstract component serves as a leaf node; performing a search by selecting the configuration plan with a higher evaluation value in the tree structure generated; and outputting the configuration plan in which all components are concretized as a concrete configuration, wherein in the outputting, an evaluation value of the configuration plan is calculated by considering an evaluation value of a logical configuration plan of the system included in the configuration plan that makes up the tree structure, and an evaluation value of a physical configuration plan of a device requiring physical arrangement included in the configuration plan.

### BRIEF DESCRIPTION OF THE DRAWINGS

FIG. 1 is a block diagram showing a configuration example of a system design device according to an exemplary embodiment.

FIG. 2 is an explanatory diagram showing an example of a description of requirements according to the exemplary embodiment.

FIG. 3 is an explanatory diagram showing an example of requirements according to the exemplary embodiment.

FIG. 4 is an explanatory diagram showing an example of a description of a concrete configuration according to the exemplary embodiment.

FIG. 5 is an explanatory diagram showing an example of a logical configuration in the concrete configuration according to the exemplary embodiment.

FIG. 6 is an explanatory diagram showing an example of a physical configuration in the concrete configuration according to the exemplary embodiment.

FIG. 7 is an explanatory diagram showing an example of a Euclidean distance d(P₁, P₂) on a coordinate plane according to the exemplary embodiment.

FIG. 8 is an explanatory diagram showing an example of a Manhattan distance d(P₁, P₂) on a coordinate plane according to the exemplary embodiment.

FIG. 9 is an explanatory diagram showing an example of a Euclidean distance d(P₁, P₂) on a coordinate plane according to the exemplary embodiment.

FIG. 10 is an explanatory diagram showing an example of a concretization means according to the exemplary embodiment.

FIG. 11A is a first explanatory diagram showing an example of a search tree according to the exemplary embodiment

FIG. 11B is a second explanatory diagram showing an example of the search tree according to the exemplary embodiment.

FIG. 12 is an explanatory diagram showing an example of configuration components and definitions of relationship type information according to the exemplary embodiment.

FIG. 13 is an explanatory diagram showing an example of description of a distance constraint topology according to the exemplary embodiment.

FIG. 14 is an explanatory diagram showing an example of a distance constraint topology according to the exemplary embodiment.

FIG. 15 is an explanatory diagram showing an example of a definition of a distance constraint topology according to the exemplary embodiment.

FIG. 16 is an explanatory diagram showing an example of distance constraints according to the exemplary embodiment.

FIG. 17 is an explanatory diagram showing an example of an arrangeable region on a two-dimensional coordinate plane according to the exemplary embodiment.

FIG. 18 is an explanatory diagram showing an example of an arrangeable region in a three-dimensional coordinate space according to the exemplary embodiment.

FIG. 19 is an explanatory diagram showing an example of a process of generating an arrangeable region on a coordinate plane according to the embodiment.

FIG. 20 is an explanatory diagram showing an example of a process of generating an arrangeable region in a coordinate space according to the embodiment.

FIG. 21 is an explanatory diagram showing an example of a process of calculating an evaluation value of a configuration plan according to the embodiment.

FIG. 22 is an explanatory diagram showing an example of a process of calculating an evaluation value of a physical configuration when the arrangeable region according to the exemplary embodiment is sufficiently large.

FIG. 23 is an explanatory diagram showing an example of a process of calculating an evaluation value of a configuration plan when there are a plurality of configuration components which are targets of generating an arrangeable region according to the exemplary embodiment.

FIG. 24 is an explanatory diagram showing an example of a process of determining an arrangement coordinate of a device for which arrangement is undetermined, performed by an arrangement determination unit according to the exemplary embodiment.

FIG. 25 is an explanatory diagram showing an example of a process of searching for a combination of temporary arrangements of devices for which arrangement is undetermined, in the process of arrangement coordinate determination according to the embodiment.

FIG. 26 is an explanatory diagram showing an example of an arrangement candidate region in a grid region according to the exemplary embodiment.

FIG. 27 is an explanatory diagram showing an example of a user interface of the system design device according to an exemplary embodiment.

FIG. 28 is a flowchart showing exemplary operations of the system design device according to the exemplary embodiment.

FIG. 29 is a flowchart showing operations of an evaluation value calculation flow according to the exemplary embodiment.

FIG. 30 is a flowchart showing operations of an arrangement coordinate determination flow according to the exemplary embodiment.

FIG. 31 is a block diagram showing an example of the minimum configuration of the system design device according to the exemplary embodiment.

### EXAMPLE EMBODIMENT

Hereinafter, automated system design processing according to each exemplary embodiment of the present disclosure will be described, with reference to the drawings. In the drawings used in the following description, the configuration of portions unrelated to the present disclosure may be omitted, and may not be illustrated.

### Exemplary Embodiment

### (Configuration)

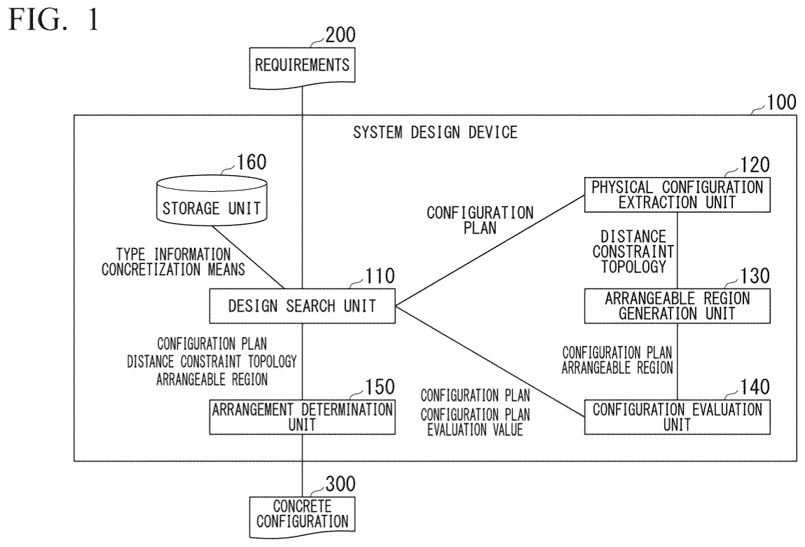

FIG. 1 is a block diagram showing a configuration example of a system design device according to an exemplary embodiment.

As shown in FIG. 1, a system design device 100 of the present exemplary embodiment includes a design search unit 110, a physical configuration extraction unit 120, an arrangeable region generation unit 130, a configuration evaluation unit 140, an arrangement determination unit 150, and a storage unit 160. The system design device 100 receives input of requirements 200 and outputs a concrete configuration 300.

An outline of the operation of the system design device 100 is described below. The system design device 100 generates a tree structure called a search tree from system configuration plans by applying a concretization means repeatedly to input requirements, to partially replace abstract components in the system's logical configuration with concrete configurations. Then, a search is performed in the search tree, and when a configuration plan in which the abstract components in the logical configuration are completely concrete is reached, this configuration plan is selected as a candidate for the concrete configuration. Furthermore, a physical configuration is generated by determining the arrangement coordinates of configuration components that are included in the selected configuration plan and require spatial arrangement, and a concrete configuration including a set of a logical configuration and a physical configuration is output.

When searching for a configuration plan in the search tree, the system design device 100 calculates an evaluation value that quantitatively quantifies the quality of the configuration for each of the logical configuration and physical configuration of the configuration plan, calculates a comprehensive evaluation value of the configuration plan from two values, the evaluation value of the logical configuration and the evaluation value of the physical configuration, and uses it as a reference for determining the quality of the configuration plan in the search. The evaluation value of a logical configuration may be calculated by an AI trained on the quality of system configurations as shown in Patent Document 1 or Non-Patent Document 1. In calculating the evaluation value of a physical configuration, a graph structure, called a distance constraint topology, representing configuration components that require spatial arrangement and distance constraints between the configuration components may be generated from the logical configuration of the configuration plan, and a numerical value quantifying the size of a region where configuration components can be arranged (hereinafter, referred to as arrangeable region) while satisfying distance constraints between configuration components with undetermined arrangement coordinates (hereinafter, referred to as arrangement undetermined devices) and configuration components with determined arrangement coordinates in the coordinate system (hereinafter, referred to as arrangement determined devices) may be used as an evaluation value.

It should be noted that in the present exemplary embodiment, the coordinate system used as the arrangement target of the configuration components may be either a two-dimensional coordinate system representing a plane or a three-dimensional coordinate system representing a three-dimensional space. In the following description, unless otherwise stated, a two-dimensional coordinate plane will be used as the target coordinate system.

Next, an overview of each functional unit of the system design device 100, and the input/output data structure of the system design device 100 will be described.

The design search unit 110 concretizes abstract components of input requirements and generates a search tree that is a tree structure of configuration plans. Then, the design search unit 110 searches the search tree, and when a configuration plan in which abstract components are completely concretized in the logical configuration is reached, selects and outputs the configuration plan. In the search process, the design search unit 110 uses the evaluation value of the configuration plan calculated by the configuration evaluation unit 140 as a reference for selecting a configuration plan, and performs search to select a configuration plan with a higher evaluation value.

The physical configuration extraction unit 120 accepts a configuration plan as input, and generates a distance constraint topology by extracting configuration components representing devices that require spatial arrangement, from the configuration plan.

The arrangeable region generation unit 130 accepts as input the distance constraint topology, and generates an arrangeable region for a configuration components corresponding to arrangement undetermined devices among devices requiring spatial arrangement. The configuration evaluation unit 140 accepts as input the arrangeable region of the arrangement undetermined devices output from the arrangeable region generation unit 130, and calculates an evaluation value of the configuration plan.

The arrangement determination unit 150 accepts as input the configuration plan, a set of the distance constraint topology, and the arrangeable region, generates a physical configuration in which the arrangement coordinates of the configuration components representing the devices that require spatial arrangement are determined, and outputs a logical configuration and a physical configuration together as a concrete configuration.

The storage unit 160 records system configuration components, type information of relationships between configuration components, and concretization means for concretizing a design.

The requirements 200 are information expressing abstract requests that the user desires from a system.

The concrete configuration 300 is information that defines the concrete configuration of a system that satisfies the requirements 200.

Next, an overview of the data structure discussed in the present disclosure will be described.

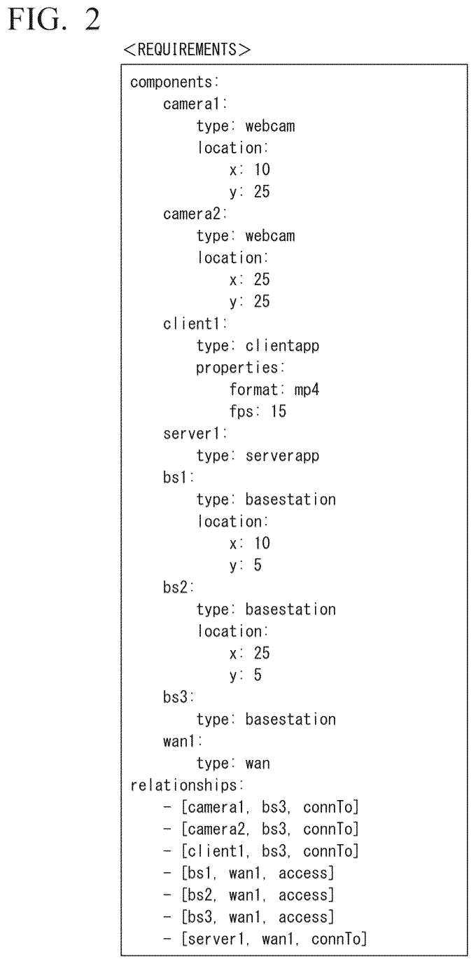

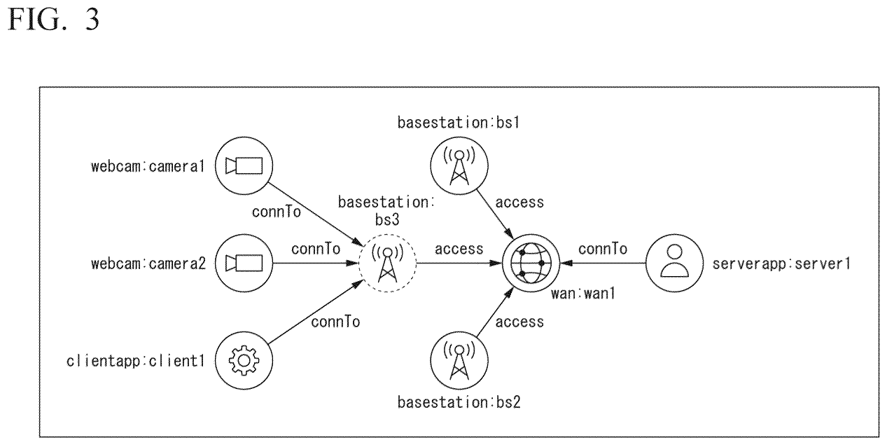

FIG. 2 shows an example of the definition of requirements 200. The requirements definition includes configuration components that the user requires of the system such as applications and devices, and abstract relationships between configuration components. Moreover, FIG. 3 is an explanatory diagram that graphically expresses the requirements shown in FIG. 2.

The requirements definition data shown in FIG. 2 includes two fields: “components”, which defines the system configuration components, and “relationships”, which defines the relationships between the configuration components. In the graph structure shown in FIG. 3 and so forth, “components” correspond to the nodes represented by circles, “relationships” correspond to the edge of the solid arrows, and “requirements” correspond to the edge of the dashed arrows and the speech bubbles. The definition of a configuration component described in “components” may include, in addition to information on the type of the configuration component “type”, information on attribute values “properties”, and information on the arrangement coordinate of a device whose location has already been determined “location”. The definition of the relationship described in “relationships” is defined by a list including three sets of information: the configuration component that is the source of the relationship request; the configuration component that is the destination of the relationship request; and relationship type information. For example, the relationship “[camera1, bs3, connTo]” indicates that the configuration component “camera1” representing a web camera is connected by some means to the configuration component “bs3” representing a base station. An arrangement coordinate described in “location” may be defined by two values: an x-axis coordinate value “x” and a y-axis coordinate value “y” on a two-dimensional plane. Moreover, in the case where the present disclosure is applied to a three-dimensional spatial coordinates, it may be defined by three values: an x-axis coordinate value “x”, a y-axis coordinate value “y”, and a z-axis coordinate value “z”.

The requirements in FIG. 2 and FIG. 3 represent the requirements for a video distribution system using wireless communication. At a base where existing mobile phone base stations “bs1”, “bs2” are installed, two web cameras “camera1”, “camera2” will be connected wirelessly to a newly installed base station “bs3”, and a client application “client1” running near this base station transmits video captured by the two web cameras to a server application “server1” via the base station “bs3” and the Internet. The client application “client1” compresses the video into the video format specified by the property “format” and the frame rate specified by the property “fps” and transmits it. The requirements in FIG. 2 and FIG. 3 specify that the video format be MPEG-4 format (mp4) and the frame rate be 15 fps (frames per second). The server application “server1” analyzes and stores the received video data.

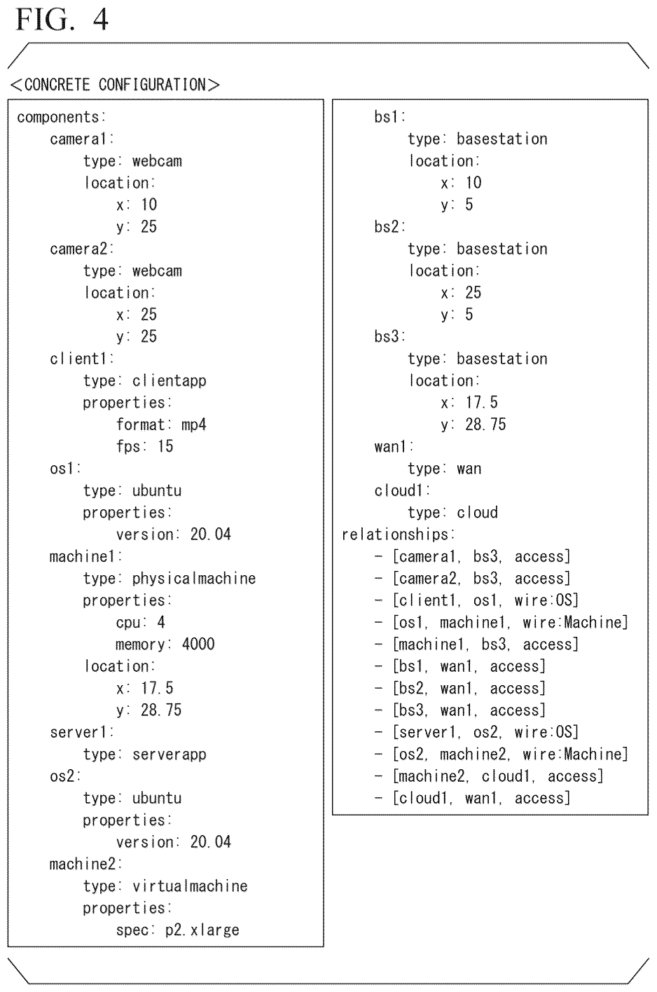

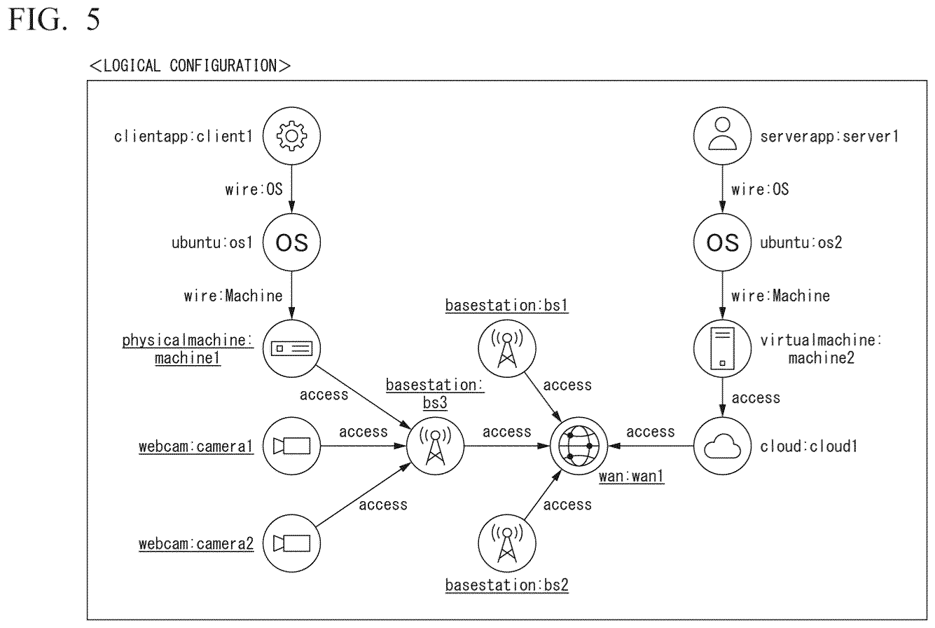

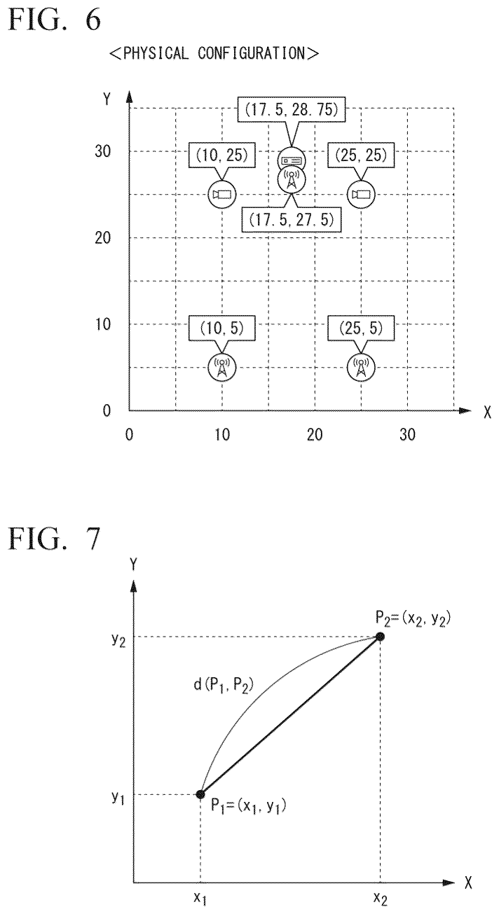

FIG. 4 shows an example of the definition of requirements 300. The definition of the concrete configuration 300 includes a logical configuration including configuration components of the system that meet the requirements and relationships between the configuration components, and a physical configuration including location coordinate information of devices requiring physical location among the configuration components. FIG. 5 shows the logical configuration of the concrete configuration 300 shown in FIG. 4, and FIG. 6 shows the physical configuration.

The concrete configuration shown in FIG. 4 to FIG. 6 are examples of system configuration information designed based on the requirements shown in FIG. 2 and FIG. 3. In the logical configuration illustrated in FIG. 5, in addition to the configuration components defined by the requirements in FIG. 2 and FIG. 3, there are additionally provided: an ubuntu-type configuration component “os1” indicating that the Ubuntu (registered trademark) Linux (registered trademark) OS is used as the OS on which a client application “client1” runs; a physicalmachine-type configuration component “machine1” representing a physical machine running the same OS; an ubuntu-type configuration component “os2” similarly representing the OS on which a server application “server1” runs; a virtualmachine-type configuration component “machine2” representing a virtual machine; and a cloud-type configuration component “cloud1” representing a cloud environment that provides a virtual machine. Moreover, applications and OSs, and OSs and virtual machines or physical machines are connected through “wire: OS”-type and “wire: Machine”-type relationships, respectively, which represent concrete host relationships, and other configuration components are connected by “access”-type configuration components that represent direct communication connections. For the configuration components “os1”, “os2” representing the OSs, “20.04” is defined in the property “version” representing the version specification of the Ubuntu (registered trademark) Linux (registered trademark) OS.

In the physical configuration shown in FIG. 6, an arrangement coordinate is defined for the arrangement of each device that satisfies the distance constraint between devices, which will be described later. These coordinates are defined for configuration components representing devices requiring arrangement, with underlined names included in the logical configuration of FIG. 5. In the example in FIG. 6, in addition to the configuration components “camera1”, “camera2”, “bs1”, and “bs2” whose arrangement coordinates have already been specified in the requirements, the configuration component “bs3” whose arrangement coordinate is undetermined and the device configuration component “machine1”, which is newly added during the configuration design process, are arranged on the coordinate plane. Moreover, a grid region is set on the coordinate plane for use in the process of generating a configuration component arrangeable region, which will be described later, and in calculating an evaluation value of a physical configuration in a configuration plan. In the description of the present specification, a grid region in which the size of one side is 5 is used. However, other values can be set for the size of one side of the grid area, and the disclosure is not limited to this example.

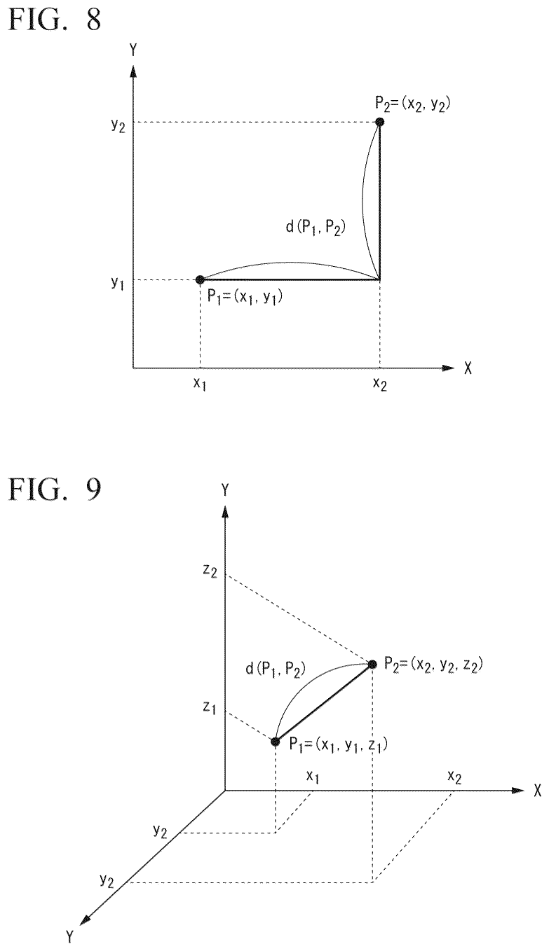

It should be noted that as an example of the distances on the two-dimensional coordinate plane used in the description of this specification, the Euclidean distance (L2 distance) shown in FIG. 7 and Equation (1) below is used. However, the device of the present disclosure may use other distances such as the Manhattan distance (L1 distance) shown in FIG. 8 and Equation (2) below. The definition of distance is not limited to Euclidean distance.

$$\begin{matrix}[ Equation 1 ] & \\ d ( {P}_{1} , {P}_{2} ) = \sqrt{{( {x}_{2} - {x}_{1} )}^{2} + {( {y}_{2} - {y}_{1} )}^{2}} & ( 1 )\end{matrix}$$

$$d ( {P}_{1} , {P}_{2} ) = \vert {x}_{2} - {x}_{1} \vert + \vert {y}_{2} - {y}_{1} \vert \qquad ( 2 )$$

Furthermore, as an example of the distances when the present disclosure uses a three-dimensional coordinate space, the Euclidean distance (L2 distance) shown in FIG. 9 and the following Equation (3) is used. However, other distance definitions may also be used. The definition of distance is not limited to Euclidean distance.

$$\begin{matrix}[ Equation 2 ] & \\ d ( {P}_{1} , {P}_{2} ) = \sqrt{{( {x}_{2} - {x}_{1} )}^{2} + {( {y}_{2} - {y}_{1} )}^{2} + {( {z}_{2} - {z}_{1} )}^{2}} & ( 3 )\end{matrix}$$

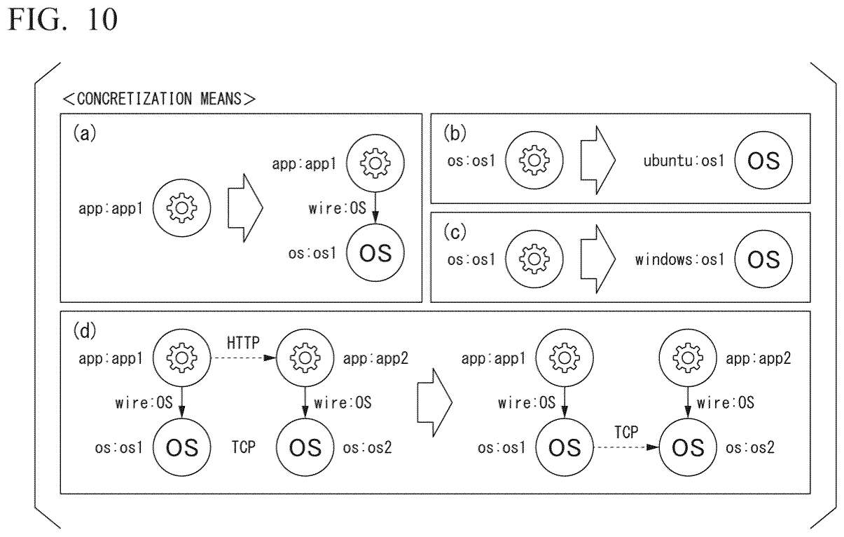

FIG. 10 illustrates an example of the concretization means. The concretization means is a piece of information that defines a means to replace a partial configuration including abstract components with a concrete configuration in a configuration plan, and is defined by a set of a partial configuration before application of the concretization means and a partial configuration after application. The concretization means of FIG. 10 (a) is to add an os-type configuration component representing an OS to an app-type configuration component representing an application, and connect the two through a concrete relationship of the wire: OS-type, thereby adding the OS on which the application will run. The concretization means in FIG. 10 (b) and FIG. 10 (c) each represent a means to convert an os-type configuration component representing an abstract OS into an ubuntu-type representing an Ubuntu (registered trademark) Linux (registered trademark) OS or into a windows-type representing a Windows (Registered Trademark) OS, and concretizes an abstract OS type added by the concretization means including FIG. 10 (a). The concretization means in FIG. 10 (d) replaces the “HTTP”-type relationship representing abstract HTTP (Hyper Text Transfer Protocol) communication between two applications “app1”, “app2” into TCP (Transmission Control Protocol) communication between the OSs on which both of the applications operate, thereby concretizing the abstract communication relationship by one step.

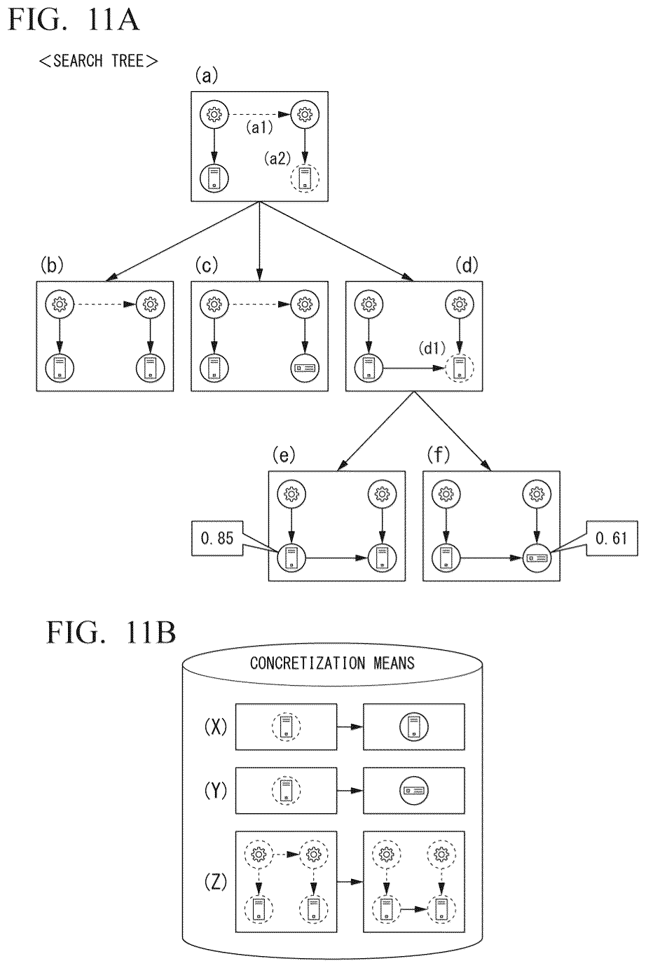

An example of a search tree is shown in FIG. 11A and FIG. 11B. The search tree is generated in the process of generating a concrete configuration from the requirements in the design search unit 110, and is expressed as a tree-structured graph where requirements serve as root nodes. Each node represents a system configuration plan, including configuration plans that are still being designed. In the process of searching for a concrete configuration in the search tree, one applicable concretization means is applied to the node representing a configuration plan that is currently being concretized, a configuration plan in which abstract components are partially concretized is generated as a node representing the next state, and a node, among the multiple generated nodes, with a larger evaluation value of the configuration plan is determined as a valid configuration plan that is closer to a concrete configuration, and is selected as the next node.

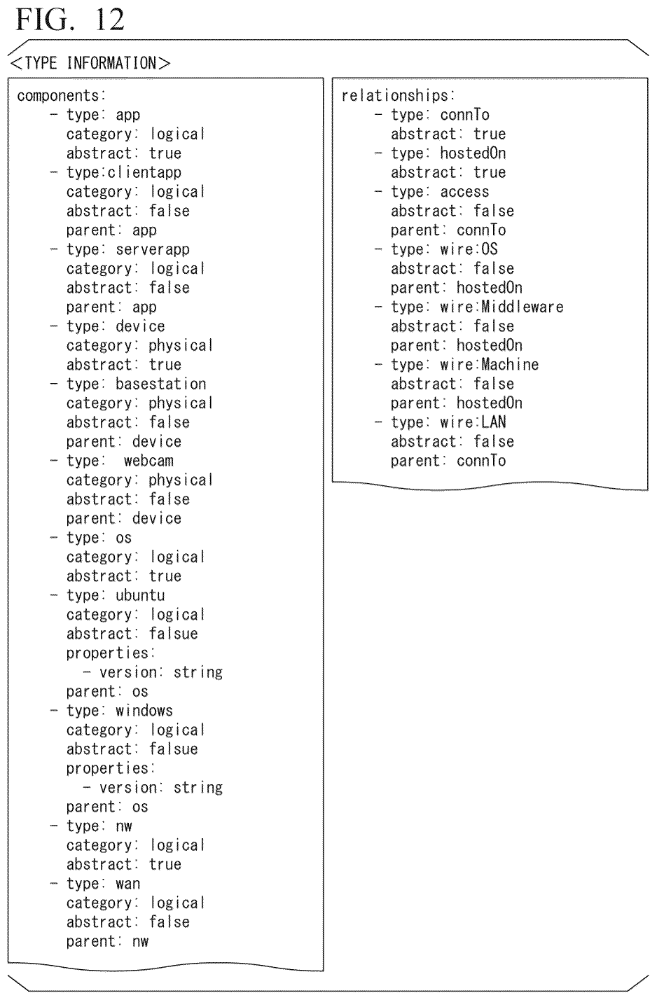

FIG. 12 illustrates an example of the definition of type information of system configuration components. The definition of type information includes fields “components”, which represent configuration components, and “relationships”, which represent relationships. Type information can also define the type of a child class that inherits the parent class type, and each item has defined fields, namely, a “type” field representing the type name, an “abstract” field being a flag indicating that the configuration component or relationship represented by the type is abstract, and a “parent” field representing the type of the inherited parent class. Moreover, in the definition of a configuration component, there is defined a “category” field representing a classification that identifies whether the configuration component is a device that requires physical arrangement or a logical component that does not require arrangement, indicating a physical configuration component if the value is “physical” and a logical configuration component if the value is “logical”.

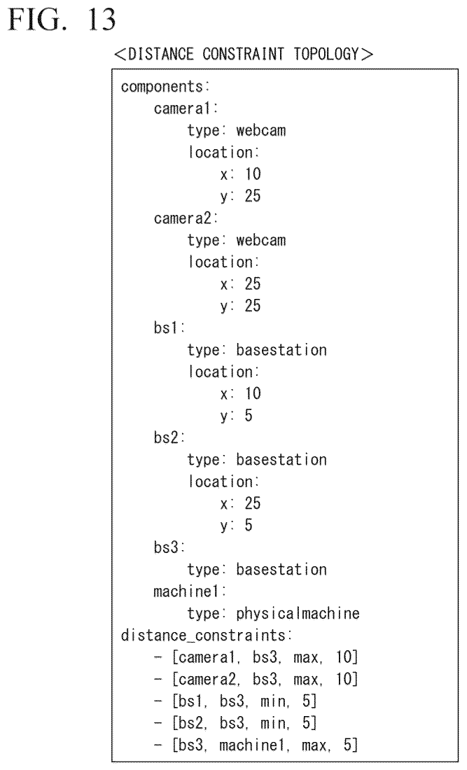

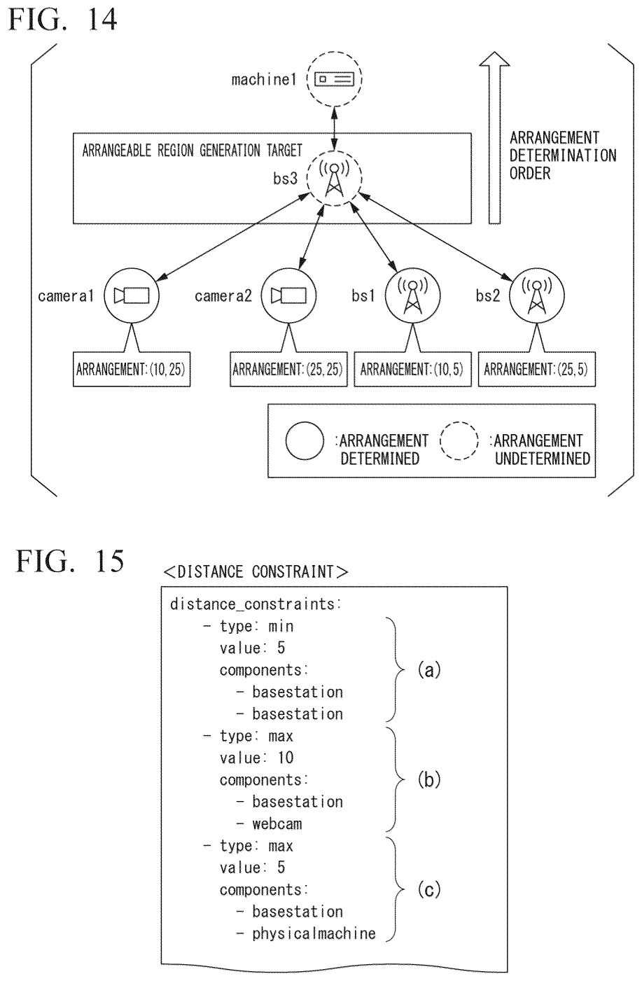

FIG. 13 illustrates an example of the definition of a distance constraint topology. FIG. 14 shows a visual representation of the distance constraint topology defined in FIG. 13. A distance constraint topology is a graph in which a device configuration component that requires physical arrangement is expressed as a node, and the distance constraint between configuration components is expressed as an edge, and devices for which arrangement coordinates are determined (hereinafter, referred to as arrangement determined devices) and arrangement undetermined devices are treated separately. Of the configuration components included in the distance constraint topology, the configuration component of an arrangement undetermined device adjacent to the configuration component of an arrangement determined device is treated as a target configuration component for arrangeable region generation of the arrangeable region generation unit 130.

As shown in FIG. 13, the definition of a distance constraint topology includes two fields: “components”, which defines configuration components that represent devices requiring arrangement, and “distance_constraints”, which defines the distance constraints between devices. For the definition of “components”, notation equivalent to the definition of requirements and concrete configurations shown in FIG. 2 and FIG. 4 may be used. In addition, the definition information of the distance constraint defined in “distance_constraints” includes a set of four values: the names of two configuration components subject to the distance constraint; the type of distance constraint; and the upper limit value or the lower limit value of the distance that requires to be met between the configuration components, which are defined in “components”. In the example of FIG. 13, the distance constraint “[camera1, bs3, max, 10]” means that: the distance between the web camera “camera1” and the base station “bs3” is not greater than 10; “max” indicating that the upper limit value of the distance is stored as the type of distance constraint; and “10” is stored in the value of the upper limit value. Similarly, the distance constraint “[bs1, bs3, max, 5]” means that: the distance between the base station “bs1” and the base station “bs3” is greater than 5; “min” indicating that the lower limit value of the distance is stored as the type of distance constraint; and “5” is stored in the value of the lower limit value.

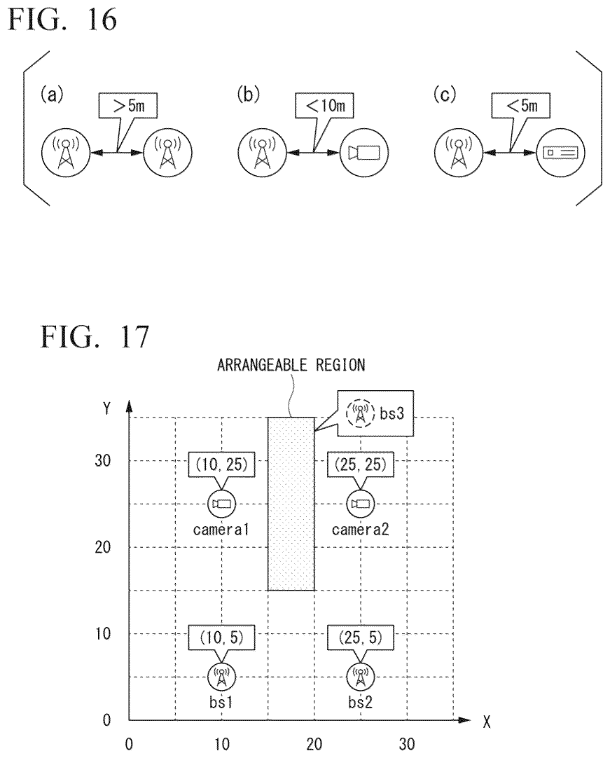

FIG. 15 illustrates an example of the definition of distance constraints. FIG. 16 shows a diagram visually representing the distance constraints shown in FIG. 15. Reference signs (a) to (c) used in FIG. 15 and FIG. 16 each represent the same distance constraint. The definition of a distance constraint is defined by a set of: the upper or lower limit value of the distance that requires to be satisfied by the distance constraint; and the types of two configuration components that are subject to the distance constraint. The distance constraint (a) defined in FIG. 15 means that when installing mobile phone base stations, it is required to ensure a certain distance or more to prevent interference between base stations. The “type” field, which defines the type of distance constraint, stores “min”, which indicates that the lower limit value of distance is set; the “value” field that defines the lower or upper limit value of the constraint stores “5”, which is the lower limit value of the distance; and the “components” field, which represents a set of configuration component types subject to the constraint, stores a “basestation” type and a “basestation” type, respectively.

FIG. 17 illustrates an example of an arrangeable region on a two-dimensional coordinate plane. The arrangeable region represents a grid region in the coordinate plane in which a configuration component representing an arrangement undetermined device can be arranged, and the arrangeable region shown in FIG. 17 represents the arrangeable region of the configuration component “bs3” in the distance constraint topology shown in FIG. 13 and FIG. 14.

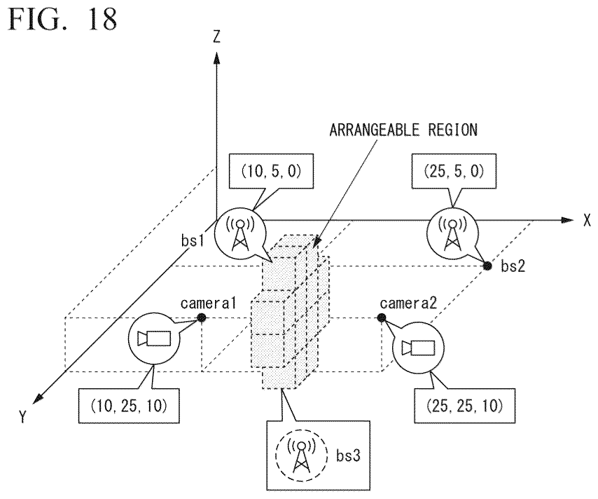

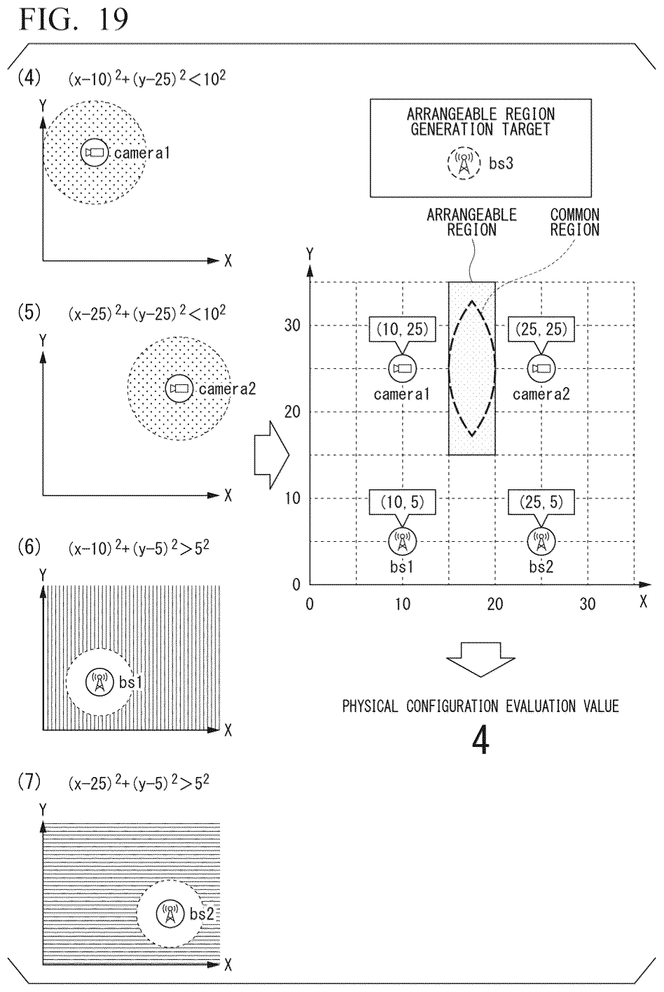

FIG. 18 illustrates an example of an arrangeable region on a three-dimensional coordinate space. In a physical configuration of a system including a device configuration similar to that of the example of FIG. 17, the arrangeable region shown in FIG. 18 represents a cubic grid region in which the configuration component “bs1” can be arranged at a coordinate (10, 5, 0), the configuration component “bs2” at a coordinate (25, 5, 0), the configuration component “camera1” at a coordinate (10, 25, 10), and the configuration component “camera2” at a coordinate (25, 25, 10).

### DETAILED DESCRIPTION

Next, the operation of each functional unit of the system design device 100 will be described in detail, with reference the drawings. The design search unit 110 makes reference to a concretization means in the storage unit 160 applicable to the requirements 200 input to the system design device 100, applies each applicable concretization means to the requirement, and generates a tree structure called a search tree where requirements serve as root nodes and configuration plans being concretized serve as nodes. Then, a search is performed for a leaf node serving as a concrete configuration in the generated search tree. In the search process, each node generated by applying the concretization means applicable to the current node is input to the physical configuration extraction unit 120 as a configuration plan.

The search process of the design search unit 110 will be described using the search tree and concretization means shown in FIG. 11A and FIG. 11B. The reference signs (a), (a1), . . . , (X), (Y), (Z), and so on used in the description here all correspond to the reference signs in FIG. 11A and FIG. 11B. In the example of FIG. 11A and FIG. 11B, the search process starts with requirement (a) as the starting point, where the concretization means (Z) is applicable to the abstract relationship (a1) included in the requirement (a) and the concretization means (X) or (Y) is applicable to the abstract configuration component (a2). Then there are generated a configuration plan (b) in which the concretization means (X) is applied, a configuration plan (c) in which the concretization means (Y) is applied, and a configuration plan (d) in which the concretization means (Z) is applied, respectively. At this time, the configuration plans (b) and (c), for which there is no applicable concretization means, are rejected as being in a state in which design concretization is not possible, and the configuration plan (d) is selected as the next node. Similarly, the concretization means (X) is applied to the configuration component (d1) of the configuration plan (d) to generate a configuration plan (e), and the concretization means (Y) is applied to generate a configuration plan (f). Then, the configuration plan (e) having the highest evaluation value is output as a logical configuration, the concretization of which has been completed.

The physical configuration extraction unit 120 accepts as input a configuration plan output from the design search unit 110, extracts from the configuration plan configuration components representing devices requiring arrangement, and outputs a distance constraint topology including the extracted configuration components. An example of the process of generating a distance constraint topology performed by the physical configuration extraction unit 120 will be described below using the examples of FIG. 13 and FIG. 14. The physical configuration extraction unit 120 makes reference to the type information of the configuration component defined in the input configuration plan (for example, FIG. 12), and extracts ones with the value “physical” in the “category” field of the type definition of the configuration component, thereby generating a “components” field of the distance constraint topology. Then, making reference to the type information of the configuration components and the definition information of the distance constraints (for example, FIG. 15), if there is a combination of configuration components in the configuration plan that matches the set of configuration component types defined in the “components” field of distance constraints, the set of four values, namely, names of the two configuration components of the above combination, the type of distance constraint specified in “type” of the distance constraint, and the value defined in “value” of the distance constraint are added to a list of distance constraints. This process is repeated for all sets of configuration components for which distance constraints can be generated, and the “distance_constraints” field of the configuration plan is generated from the contents of the distance constraint list.

The arrangeable region generation unit 130 accepts as input, the distance constraint topology output from the physical configuration extraction unit 120, and outputs an arrangeable region for devices for which arrangement coordinates are undetermined (hereinafter, referred to as arrangement undetermined devices) among the devices that require spatial arrangement.

An arrangeable region is used by the configuration evaluation unit 140 to calculate the evaluation value of a physical configuration in a configuration plan. The configuration evaluation unit 140 derives a common region that satisfies a distance constraint with adjacent arrangement determined devices on a distance constraint topology, for each configuration component which is the target of generating an arrangeable region in the distance constraint topology, and outputs a grid region that includes the common region as an arrangeable region.

FIG. 17 illustrates an example of an arrangeable region on a two-dimensional plane, generated by the arrangeable region generation unit 130, and an overview of the arrangeable region generation means. In the example of FIG. 17, in the physical configuration of the configuration plan the distance constraint topology of which is shown in FIG. 13 and FIG. 14, then with respect to the configuration component “bs3” representing the base station being the target of generating an arrangeable region, the regions satisfying the distance constraints with the configuration components that are adjacent devices on the distance constraint topology are given by Inequation (4) to Inequation (7) below.

$$Between camera 1 and bs 3 : {( x - 10 )}^{2} + {( y - 25 )}^{2} < 1 {0}^{2} \qquad ( 4 )$$

$$Between camera 2 and bs 3 : {( x - 25 )}^{2} + {( y - 25 )}^{2} < 1 {0}^{2} \qquad ( 5 )$$

$$Between bs 1 and bs 3 : {( x - 10 )}^{2} + {( y - 5 )}^{2} < {5}^{2} \qquad ( 6 )$$

$$Between bs 1 and bs 3 : {( x - 25 )}^{2} + {( y - 5 )}^{2} < {5}^{2} \qquad ( 7 )$$

These common regions are represented by the shaded regions on the coordinate plane in FIG. 17, and the grid region that includes the common regions is output as an arrangeable region for “bs3”.

Moreover, the example of FIG. 18 is an example of an arrangeable region in a three-dimensional space. The example of FIG. 18, in the physical configuration including components similar to those of the distance constraint topology shown in FIG. 13 and FIG. 14, there is illustrated the process of deriving the arrangeable region for the basestation-type configuration component “bs3” in the case where “camera1” is arranged at a coordinate (10, 25, 10), “camera2” at a coordinate (25, 25, 10), “bs1” is at a coordinates (10, 5, 0), and “bs2” at a coordinate (25, 5, 0). Regions that satisfy the distance constraints between “bs3” and other configuration components are given by the Inequation (8) to Inequation (11) below, and the grid region that includes these common regions is output as an arrangeable region for “bs3”.

$$Between camera 1 and bs 3 : {( x - 10 )}^{2} + {( y - 25 )}^{2} + {( z - 10 )}^{2} < 1 {0}^{2} \qquad ( 8 )$$

$$Between camera 2 and bs 3 : {( x - 25 )}^{2} + {( y - 25 )}^{2} + {( z - 10 )}^{2} < 1 {0}^{2} \qquad ( 9 )$$

$$Between bs 1 and bs 3 : {( x - 10 )}^{2} + {( y - 5 )}^{2} + {z}^{2} < {5}^{2} \qquad ( 10 )$$

$$Between bs 1 and bs 3 : {( x - 25 )}^{2} + {( y - 5 )}^{2} + {z}^{2} < {5}^{2} \qquad ( 11 )$$

The configuration evaluation unit 140 accepts as input the arrangeable region of the arrangement undetermined devices output from the arrangeable region generation unit 130, and it calculates an evaluation value of the configuration plan and outputs it together with the configuration plan.

As an example of the process of calculating the evaluation value of a configuration plan in the configuration evaluation unit 140, FIG. 19 illustrates process of calculating the evaluation value for a configuration plan having the logical configuration shown in FIG. 4 and the physical configuration with the distance constraint topology shown in FIG. 12 and FIG. 13. The configuration evaluation unit 140 calculates an evaluation value for each of the logical configuration and physical configuration in the configuration plan, and calculates the evaluation value of the configuration plan by calculating a linear weighted sum based on weights.

The evaluation value of a logical configuration can be calculated by: a means of determining as an evaluation value, the ratio of the total number of concrete (that is, non-abstract) configuration components and relationships, to the total number of configuration components and relationships in the logical configuration; or a means of evaluating through numerical quantification, which serves as an evaluation value, the likelihood of the logical configuration in a configuration plan reaching a concrete logical configuration, the likelihood being calculated by a graph neural network (GNN) that has been preliminarily trained on designing processes with a variety of requirements, as described in Non-Patent Document 1. Note that the calculation means described above is an example, and the disclosure is not limited to this example.

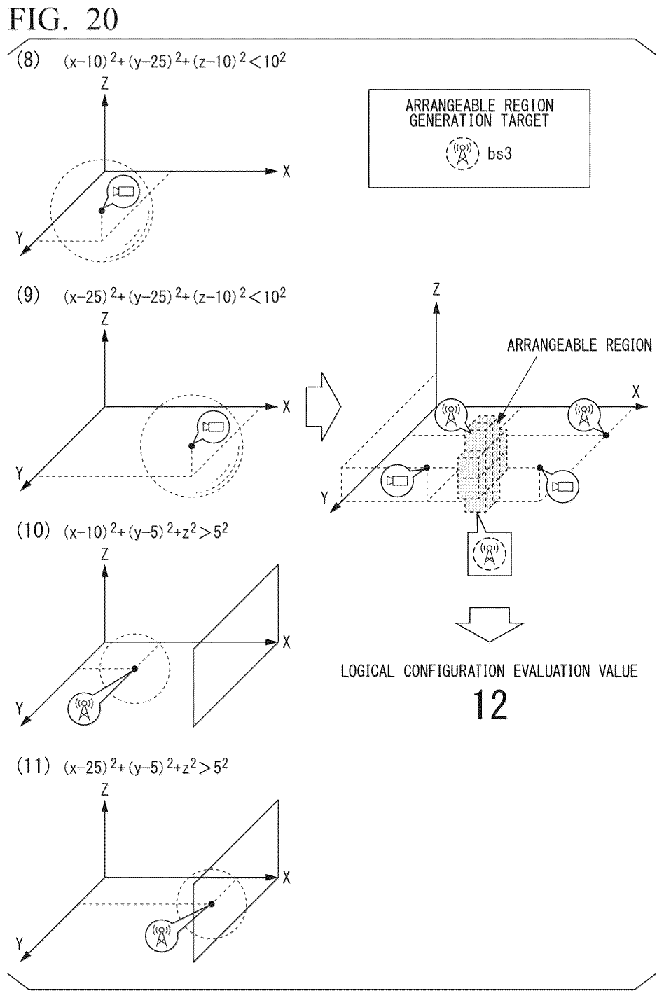

Moreover, the evaluation value of a physical configuration can be calculated as an evaluation value by a means of calculating the number of grid regions occupied by the arrangeable region on the coordinate plane shown in FIG. 17, or by a means of calculating as an evaluation value the area of the arrangeable region on the coordinate plane. In the case of a three-dimensional space, the evaluation value of a physical configuration can be calculated as an evaluation value by a means of calculating the number of grid regions occupied by the arrangeable region in the coordinate space shown in FIG. 18, or by a means of calculating the volume of the arrangeable region as an evaluation value. When calculating the number of grid regions occupied by the arrangeable region as an evaluation value, the evaluation value of the physical configuration on the coordinate plane of FIG. 17 is calculated as 4, and the evaluation value of the physical configuration in the coordinate space of FIG. 18 is calculated as 12 (see FIG. 20). Note that the calculation means described above is an example, and the disclosure is not limited to this example.

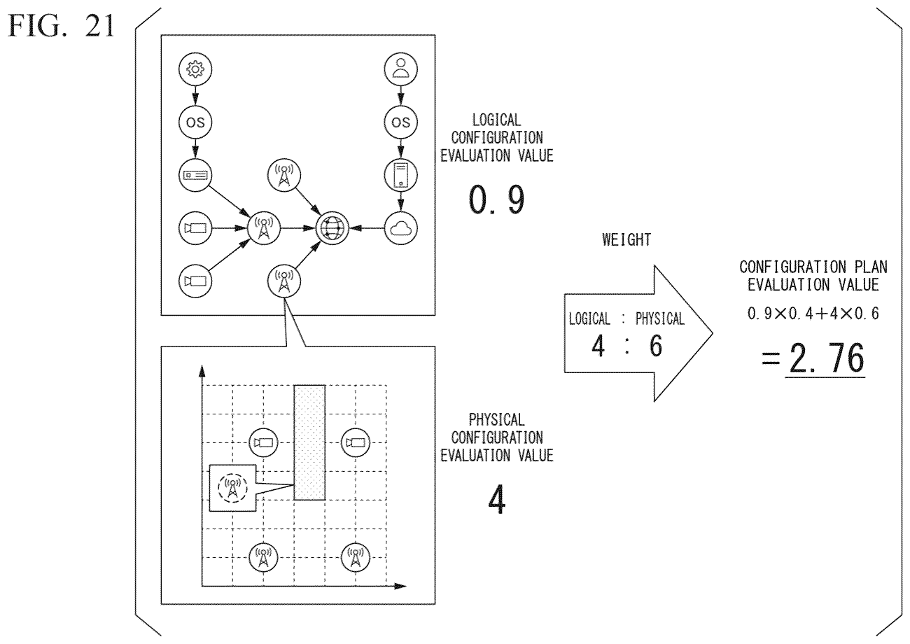

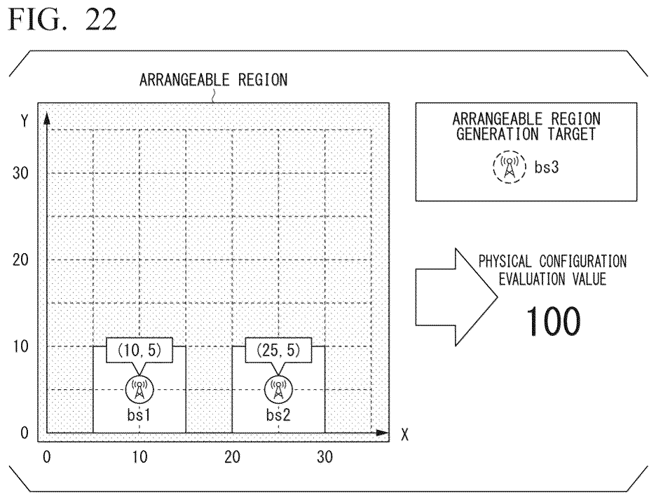

As shown in the example of FIG. 21, after calculating the evaluation values for both the logical configuration and the physical configuration, the evaluation value of the configuration plan is calculated by taking a weighted average value based on weights. In the example in FIG. 21, if the evaluation value of the logical configuration is calculated as 0.9 and the evaluation value of the physical configuration is calculated as 4, the weighted average value 2.76 obtained using “logical configuration: physical configuration=4:6” as the weight of the evaluation value is output as the evaluation value of the configuration plan. Note that, as the weight of the evaluation value, a value fixed preliminarily by a disclosed device may be used, or a value specified by the user in the requirements may be used. If the arrangeable region is sufficiently large and the evaluation value of the physical configuration diverges to infinity, a preset upper limit value is used as the evaluation value of the physical configuration. For example, as shown in FIG. 22, if the number of grid regions included in the arrangeable region exceeds the upper limit value where the upper limit value of the evaluation value of the physical configuration is set to 100, the evaluation value of the physical configuration may be output as 100.

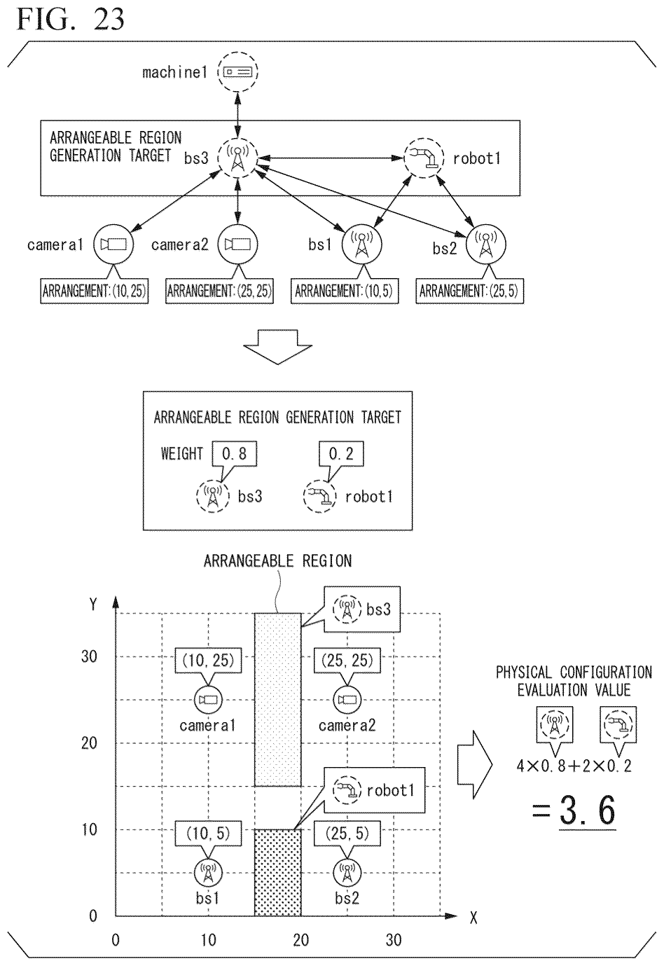

FIG. 23 schematically illustrates the operations of the arrangeable region generation unit 130 and the configuration evaluation unit 140 when there are a plurality of configuration components for which an arrangeable region is to be generated in the distance constraint topology. For each of the generation target configuration components, the arrangeable region generation unit 130 generates arrangeable regions for configuration components representing arrangement determined devices, and the configuration evaluation unit 140 independently calculates the evaluation value of the physical configuration for each arrangeable region, and outputs as the evaluation value of the overall physical configuration, the weighted average value of each evaluation value based on the weights defined for the target configuration components for arrangeable region generation. The weights of the configuration components may be defined preliminarily by the user as requirements, or a simple average value may be output if the weights are not defined. In the example of FIG. 23, the arrangeable region includes two configuration components: “bs3”, a base station type-configuration component representing a base station, and “robot1”, a robot-type configuration component representing a robot that can be controlled via wireless communication. The arrangeable region generation unit 130 generates an arrangeable region for each configuration component as shown on the coordinate plane at the lower left of FIG. 23, and the configuration evaluation unit 140 calculates the physical configuration evaluation value of 4 for the configuration component “bs3” and the physical configuration evaluation value of 2 for the configuration component “robot1.” Then, 3.6, which is a weighted average value obtained using both weights, is output as the evaluation value of the physical configuration in the configuration plan.

Furthermore, the design search unit 110 selects the configuration plan with the highest evaluation value as the next node, from the set of configuration plans and evaluation values of the configuration plans input multiple times from the configuration evaluation unit 140, and updates the current node with the selected node. Moreover, the design search unit 110 determines whether or not the logical configuration of the configuration plan represented by the updated node is completely concretized, and if the logical configuration is completely concretized, inputs to the arrangement determination unit 150 a set of three: the configuration plan; the distance constraint topology generated by the physical configuration extraction unit 120; and the arrangeable region generated by the arrangeable region generation unit 130.

The arrangement determination unit 150 accepts as input the set of the configuration plan, the distance constraint topology, and the arrangeable region output by the design search unit 110 when the generation of the logical configuration is determined as completed, and outputs as a concrete configuration a set of a physical configuration and a logical configuration in which arrangement coordinates of configuration components representing all devices are determined. It should be noted that if there are no arrangement coordinates that satisfy the distance constraints for all arrangement undetermined device, the configuration plan is rejected and the process returns to the configuration plan search process in the design search unit 110.

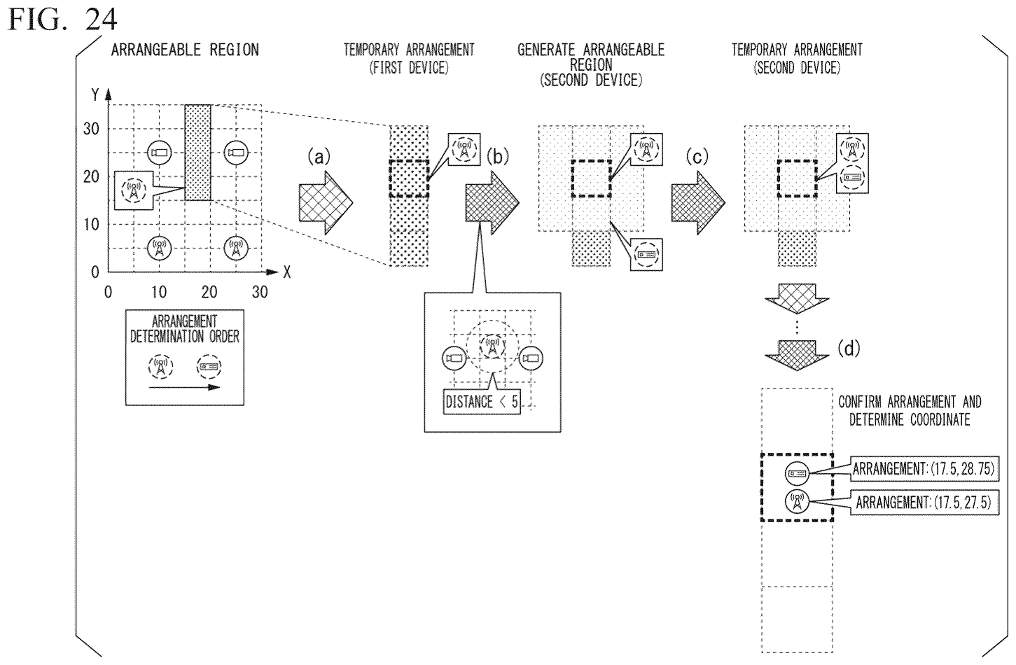

FIG. 24 schematically illustrates the arrangement coordinate determination process performed by the arrangement determination unit 150. The physical configuration extraction unit 120 determines the arrangement of configuration components representing arrangement undetermined devices included in the physical configuration, in the order of arrangement determined based on the distance constraint topology. The content shown in FIG. 24 represents the process of determining the arrangement coordinates of the physical configuration the distance constraint topology of which is shown in FIG. 13 and FIG. 14, and the arrangement of the configuration components “bs3” and “machine1” is determined in this order. First, one of the grid regions included in the arrangeable region of the first device in the order of arrangement determination (hereinafter referred to as “first device”) is selected and the first device is temporarily arranged ((a) of FIG. 24). Next, an arrangeable region is generated based on the distance constraint between the second device in the order of arrangement determination (hereinafter referred to as “second device”), and the first device and the arrangement determined devices ((b) of FIG. 24). Then, one of the grid regions included in the arrangeable region of the second device is selected, and the second device is temporarily arranged ((c) of FIG. 24). The same process is performed for all arrangement undetermined devices, and when the temporary arrangement of all devices is completed, the grid region in which each device is arranged is concluded, the detailed coordinates of the device within the grid region are determined, and the physical configuration is output.

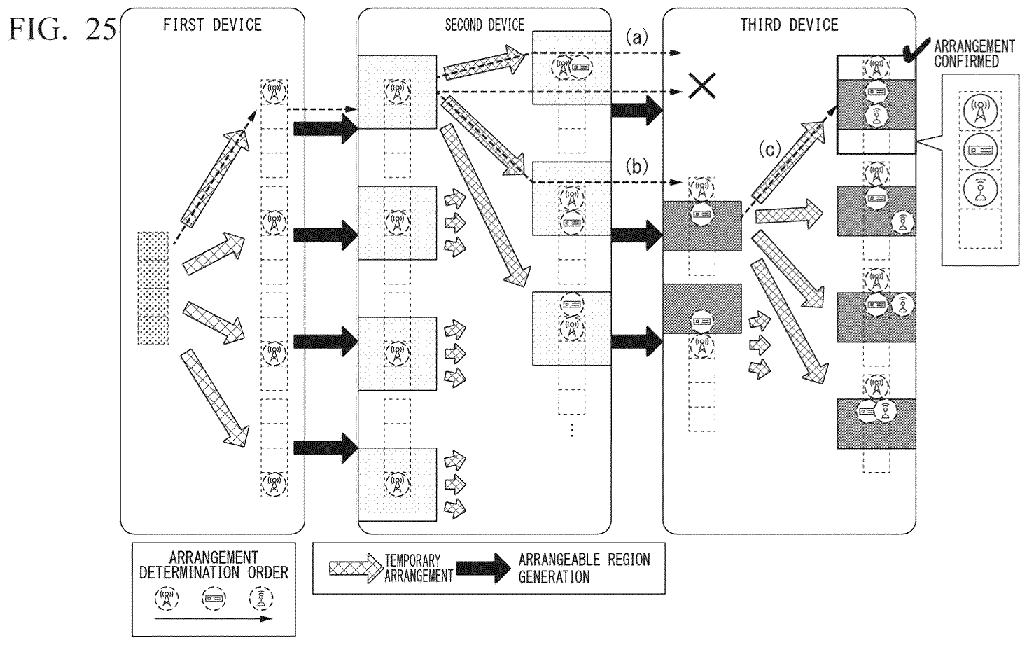

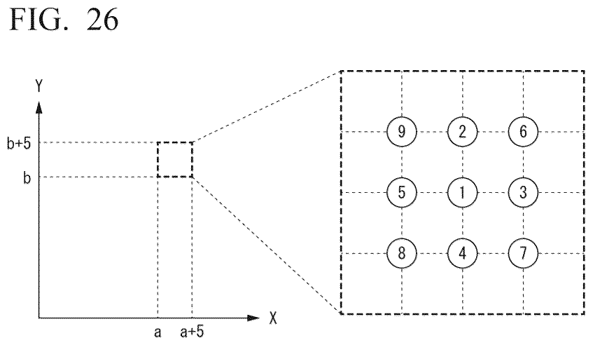

If there is no arrangeable region during the process of temporarily arranging a device, as shown in FIG. 25, the temporary arrangement of the preceding device in the order of arrangement determination is redone, and the process of temporarily arranging the device and generating an arrangeable region is repeated until the temporary arrangement of all devices is completed. If there is no region satisfying the distance constraint and there is no arrangeable region when temporary arrangement of up to the n-1th device is completed according to the arrangement determination order defined by the distance constraint topology and the nth arrangeable region is to be generated ((a) of FIG. 25), a different temporary arrangement pattern for the n−1th device is selected ((b) of FIG. 25), and if newly generating an arrangeable region for the nth device is possible, one grid region that would be included in the arrangeable region is selected to complete the temporary arrangement ((c) of FIG. 25).

FIG. 26 illustrates an example of a means for determining an arrangement coordinate after having determined a grid region serving as the arrangement target for a configuration component. Within each grid region, a plurality of arrangement candidate coordinates with the prescribed order of priority are defined preliminarily, and coordinates are determined in the order of priority in accordance with the arrangement determination order defined by the distance constraint topology, according to the number of arrangement undetermined devices to be placed in the grid region. In the example in FIG. 26, the following candidate coordinates are defined as intersection points of auxiliary lines further dividing one side of a grid region, which has a side length of 5, into four equal parts (the numbers following the “candidates” below correspond to the numbers inside the circles in FIG. 26). Candidate 1: (a+2.5, b+2.5), candidate 2: (a+2.5, b+3.75), candidate 3: (a+3.75, b+2.5), candidate 4: (a+2.5, b+1.25), candidate 5: (a+1.25, b+2.5), candidate 6: (a+3.75, b+3.75), candidate 7: (a+3.75, b+1.25), candidate 8: (a+1.25, b+1.25), candidate 9: (a+1.25, b+3.75). It should be noted that the means for determining arrangement coordinates is only an example, and the disclosure is not limited to the example of FIG. 26.

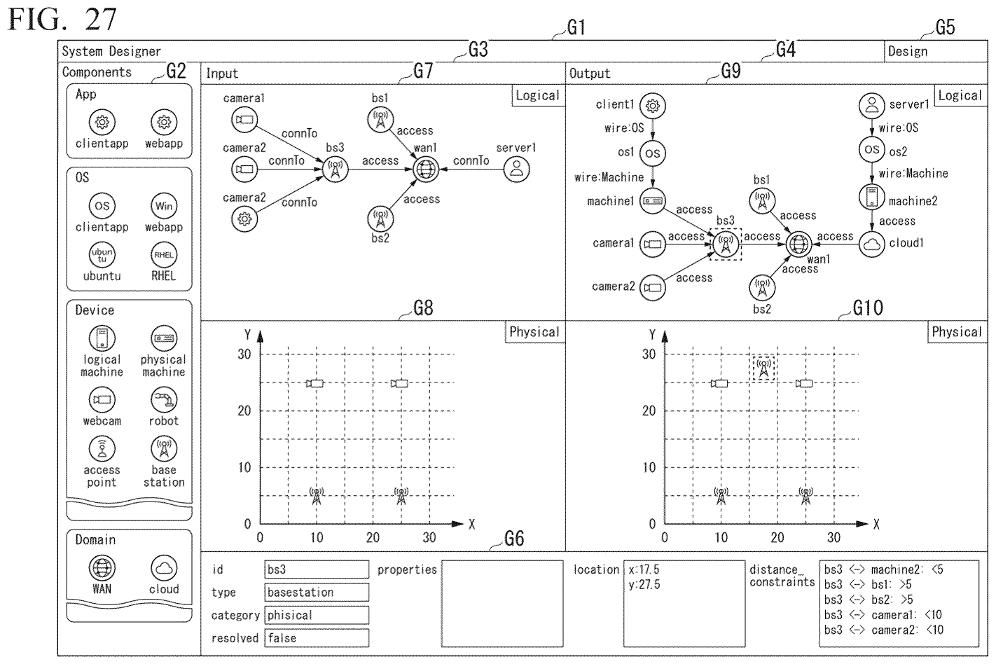

FIG. 27 is a diagram showing an example of a screen display according to the present exemplary embodiment. This screen display G1 is a user interface (Graphical User Interface: GUI) of the system design device 100. The user is, for example, a designer who designs systems. The screen display G1 includes a configuration components library G2, a requirements input form G3, a concrete configuration output form G4 for displaying a design result concrete configuration, a design button G5, and a sub window G6 for displaying information on requirements, configuration components and relationships being configured concretely, and arrangement coordinates in a physical configuration. The requirements input form G3 is composed of a logical configuration input form G7 and a physical configuration input form G8, and, similarly, the concrete configuration output form G4 is composed of a logical configuration output form G9 and a physical configuration output form G10. In the sub window G6, the ID of a component selected in requirements input form G3 or concrete configuration output form G4 is displayed in the “id” field, and the type name of selected component is displayed in the “type” field. The “category” field displays either the character string “logical” indicating that the selected component is a logical component, or the character string “physical” indicating that the selected component is a physical component. The “resolved” field displays a flag indicating that the component has been replaced with a concrete configuration during the design process and does not exist in the actual configuration. The “properties” field displays information on an attribute value of the selected component, and the “distance_constraints” field displays information on a distance constraint defined between the selected component and another component. In the configuration components library G2, the types of system configuration components defined in the storage unit 160 are arranged by category such as App (application) and OS, and the user can arrange configuration component nodes in the logical configuration input form from this library, and create a graph structure of a logical configuration of requirements by connecting the nodes with relationship edges. Moreover, in the case where the requirements include a configuration component for which an arrangement coordinate has been determined, the arrangement coordinate can be defined by selecting the configuration component in the logical configuration input form G7, and inputting the coordinate information in the “location” field of the sub window G6, or moving the position of the configuration component on the physical configuration input form G8. Upon pressing down the design button G4 after having input the requirements in the input form G3, the logical configuration of the concrete configuration designed by the system design device 100 is displayed in the logical configuration output form G9, and the physical configuration of the concrete configuration is output in the physical configuration output form G10, respectively. Upon selecting a node (configuration component) or an edge (relationship) of the graph structure of the requirements displayed in the input form G3 or the configuration plan displayed in the output form G5, detailed information of the selected component or relationship is displayed in the sub window G6. The example of FIG. 27 represents a screen display in the case where the requirements shown in FIG. 2 and FIG. 3 are designed and the concrete configuration shown in FIG. 4 to FIG. 6 are output. On the screen display, the configuration component “bs3” in the concrete configuration is selected, and information such as the ID, type information, arrangement coordinate, and distance constraints of the same configuration component are displayed in the sub window G6.

### (Operations)

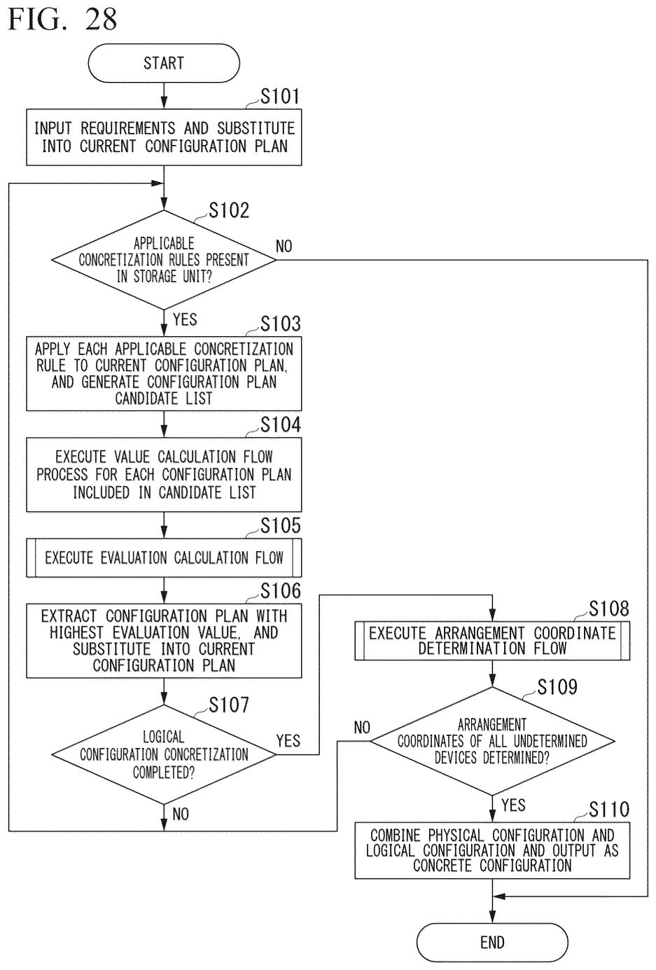

Next, the overall operation of the present exemplary embodiment will be described in detail, with reference to the flowchart of FIG. 28.

First, requirements information is input to the design search unit. The design search unit 110 substitutes the input requirements information into the current configuration plan (Step S101). Next, the design search unit 110 makes reference to the concretization means from the storage unit 160 and determines whether there is any concretization means applicable to the current configuration plan (Step S102). If there is no applicable concretization means (No in Step S102), it is determined that the design of the concrete configuration has failed, and the operation ends. If applicable concretization means exist (Yes in Step S102), the design search unit 110 generates a configuration plan candidate list based on configuration plans obtained by applying each concretization means to the current configuration plan. (Step S103). Then, the design search unit 110 executes the process of the value calculation flow for each of the configuration plans included in the configuration plan candidate list. In the value calculation flow, a configuration plan is received as input and the evaluation value of the configuration plan is output (Step S105).

After having completed the process of the value calculation flow for the configuration plans included in the configuration plan candidate list, the design search unit 110 extracts the configuration plan with the highest evaluation value from the configuration plan candidate list and substitutes it into the current configuration plan (Step S106). Then, the design search unit 110 determines whether the concretization of the logical configuration has been completed for the current configuration plan (Step S107). If the concretization has not been completed (No in Step S107), it is determined that further concretization means requires to be applied to the current configuration plan, and the process returns to Step S102. If the concretization has been completed (Yes in Step S107), the process of the arrangement coordinate determination flow is executed (Step S108). In the arrangement coordinate determination flow, a configuration plan, distance constraint topology, and arrangeable region are received, and a concrete configuration is output.

After having completed the processing of the arrangement coordinate determination flow, the arrangement determination unit 150 determines whether the arrangement coordinates of all arrangement undetermined devices in the physical configuration have been determined (Step S109), and if they have not been determined (No in Step S109), it is determined that a redesign regarding the logical configuration is necessary, and the process returns to Step S102. If they have been determined (Yes in Step S109), the arrangement determination unit 150 determines that the design of the physical configuration has also been completed, and generates and outputs a concrete configuration by combining the physical configuration and the logical configuration (Step S110).

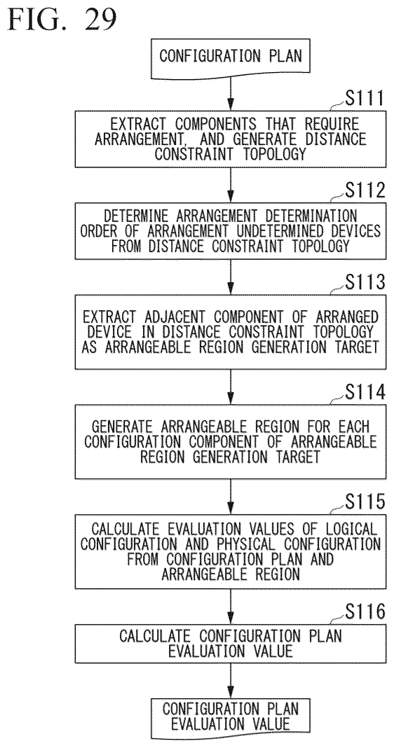

Next, details of the evaluation value calculation flow (Step S105) will be described, using FIG. 29. The physical configuration extraction unit 120 makes reference to the configuration plan input to the evaluation value calculation flow, extracts configuration components that require physical arrangement based on the type information of the configuration components, generates a distance constraint topology based on the definition information of the distance constraints (Step S111), and inputs it to the arrangeable region generation unit 130. Moreover, the physical configuration extraction unit 120 determines the arrangement determination order of arrangement undetermined devices in the arrangement determination unit 150 based on the distance constraint topology (Step S112). For example, the physical configuration extraction unit 120 determines the arrangement determination order in descending order of the hop count from the configuration components representing the arrangement determined devices in the distance constraint topology. For example, in the cases of the example of FIG. 13 and FIG. 14, the physical configuration extraction unit 120 calculates the hop count of the arrangement undetermined devices (bs3, machine1) from the arrangement determined devices (camera1, camera2, bs1, bs2), determines first the arrangement of bs3, which has a small hop count, and then determines the arrangement of machine1. Next, the arrangeable region generation unit 130 extracts the configuration component adjacent to the configuration component of the arrangement determined device in the distance constraint topology as the target of arrangeable region generation (Step S113). Then, the arrangeable region generation unit 130 calculates a common range on the coordinate plane for each configuration component being the target of arrangeable region generation, based on distance constraints with adjacent arrangement determined device in the distance constraint topology, and thereby generates an arrangeable region (Step S114) and inputs it into the configuration evaluation unit 140 together with the configuration plan. The configuration evaluation unit 140 calculates evaluation values of both of the logical configuration and the physical configuration in the configuration plan from the input configuration plan and arrangeable region (Step 115). Then, the configuration evaluation unit 140 calculates and outputs the evaluation value of the configuration plan by a weighted average of the evaluation values of the logical configuration and the physical configuration (Step S116).

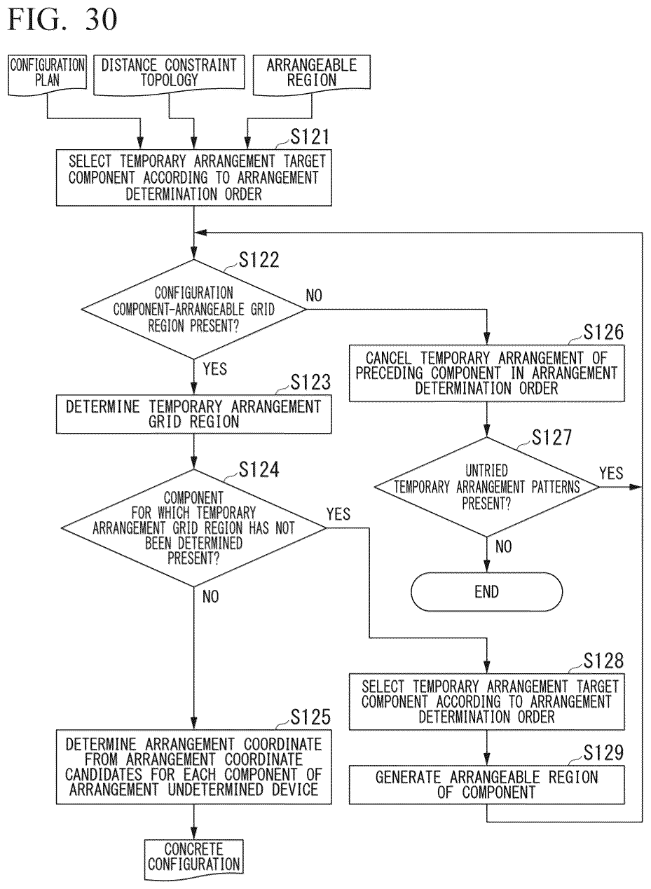

Next, details of the arrangement coordinate determination flow (Step S108) will be explained, using FIG. 30.

The arrangement determination unit 150 selects one configuration component to be temporarily arranged according to the order of configuration components arrangement determined by the physical configuration extraction unit 120 (Step S121). If there is a grid region in which the selected configuration component can be arranged (Yes in Step S122), one grid region in which to temporarily arrange the configuration component is selected and determined (Step S123). If there is no grid region in which such arrangement is possible (No in Step S122), the last temporary arrangement of the configuration component is canceled (Step S126), and it is determined whether there is an untried temporary arrangement pattern (Step S127). If there is an untried pattern (Yes in Step S127), the process returns to Step S122 and continues to try temporary arrangement of the configuration component. If there is no untried pattern (No in Step S127), it is determined that it is impossible to determine the arrangement coordinate of the arrangement undetermined device in the physical configuration of the configuration plan, and the operation of the arrangement coordinate determination flow ends.

After having executed Step S123, the arrangement determination unit 150 determines whether there is a configuration component in the physical configuration of the configuration plan for which no grid region for temporarily arranging it therein has been determined (Step S124). If there is a configuration component for which no grid region for temporarily arranging it therein has been determined (Yes in Step S124), one configuration component to be temporarily arranged is selected in accordance with the arrangement determination order (Step S128). Then the arrangeable region for the selected configuration component is generated based on the distance constraint topology and the information of the temporarily arranged configuration component (Step S129), and the process returns to Step S122. If there is no configuration component in the physical configuration of the configuration plan for which no grid region is determined for temporarily arranging it therein, that is, if temporary arrangement of all configuration components have been completed (No in Step S124), the arrangement determination unit 150 determines an arrangement coordinate for each configuration component of the arrangement undetermined devices from the arrangement coordinate candidates included in the grid region in which the configuration components are temporary arranged, and outputs the set of the physical configuration and logical configuration as a concrete configuration (Step S125).

### (Effects)

As mentioned above, the present exemplary embodiment enables the automated generation of a logical configuration of applications and networks meeting system requirements, as well as a physical arrangement configuration of devices such as servers and wireless terminals that require physical arrangement. In the design techniques disclosed in Patent Document 1 and Non-Patent Document 1, only evaluation values of logical configurations are considered in conducting search of the search tree, whereas in the present exemplary embodiment, evaluation values that take into account both logical and physical configurations are used as selection reference for configuration plans during the search process. Therefore, it is possible to suppress the occurrence of rework caused by outputting concrete configurations that make spatial arrangement of configuration components impossible even if the logical configuration thereof is correct. This enables further acceleration of design compared to conventional techniques. As a result, it becomes further possible to reduce the burden on engineers involved in system design, which previously required manual adjustments. The present exemplary embodiment is applicable for various purposes including the design and construction of ICT systems and communication networks.

### (Minimum Configuration)

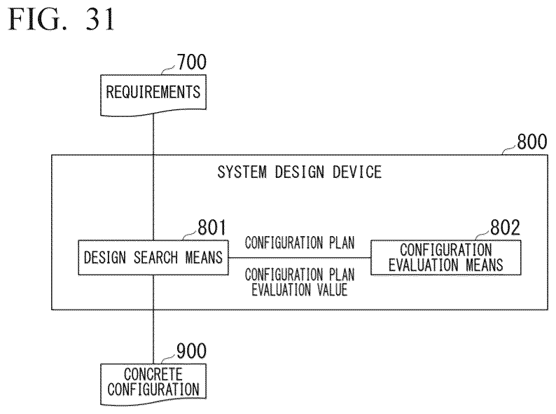

FIG. 31 is a block diagram showing an example of the minimum configuration of the system design device according to the exemplary embodiment. A system design device 800 is a system design device that receives requirements 700 of a system as input and outputs a concrete configuration of the system, comprising a design search unit 801 and a configuration evaluation unit 802.

The design search unit 801 generates, by repeatedly applying to the requirements a concretization means that converts an abstract component included in the system into a concrete configuration, a tree structure in which the requirements serve as a root node and a configuration plan of the system concretizing the abstract component serves as a leaf node, that performs a search by selecting the configuration plan with a higher evaluation value in the tree structure generated, and that outputs the configuration plan in which all components are concretized as a concrete configuration 900.

The configuration evaluation unit 802 calculates an evaluation value of the configuration plan by considering an evaluation value of a logical configuration plan of the system included in the configuration plan that makes up the tree structure, and an evaluation value of a physical configuration plan of a device requiring physical arrangement included in the configuration plan.

Part or all of the system design devices 100, 800 in the exemplary embodiment described above may be implemented by means of a computer. In such a case, a program for implementing this function may be recorded on a computer-readable recording medium, and the program recorded on the recording medium may be read into a computer system and executed. The “computer system” here is a computer system built in the system design devices 100, 800, and includes an OS (operating system) and hardware such as peripheral devices.

Moreover, the “computer-readable recording medium” here refers to a portable medium such as a flexible disk, a magnetic optical disk, a ROM, and a CD-ROM, or a memory storage device such as a hard disk built in a computer system. Furthermore, the computer-readable recording medium” may refer to those that dynamically store programs for a short period of time, such as communication lines used for transmitting programs using networks such as the Internet and communication lines such as telephone lines. It may also include a volatile memory inside a computer system serving as a server or a client, which holds programs for a certain period of time. The above program may be a program for realizing a part of the functions described above, and may be a program capable of realizing the functions described above in combination with a program already recorded in a computer system.

Also, part or all of the system design devices 100, 800 in the exemplary embodiments described above may be implemented as an integrated circuit such as LSI (Large Scale Integration). Each functional unit of the system design devices 100, 800 may be individually made into a processor, or may be partially or entirely integrated into a processor. Also, the method of circuit integration is not limited to LSI, but may be realized by a dedicated circuit or a general-purpose processor. Furthermore, when an integrated circuit technology that replaces LSI appears due to the advancement of semiconductor technology, an integrated circuit based on this technology may be used.

As mentioned above, in the conventional automated design techniques described in Patent Document 1 and Non-Patent Document 1, the design of system configurations involving devices requiring spatial arrangement does not take into account distance constraints such as wiring length between devices, effective range of wireless connections, and radio interference. Hence, the physical configuration of the system is required to be determined manually. Moreover, the conventional network design support device described in Patent Document 2 also falls short of fully automating the design process, as it assumes that the logical configuration of the system, including the network, has been pre-designed.

There is a demand for a technique that consistently automates the design process of systems, including physical devices, by taking into consideration both logical and physical configurations of the system and by automatically determining the physical configuration, which includes the coordinates of device arrangement considering distance constraints, in addition to designing logical configurations.

According to the present disclosure, it is possible, for example, to automatically generate both the logical and physical configurations of the system.

One exemplary embodiment of the present disclosure has been described in detail with reference to the drawings. However, the specific configuration of the disclosure is not limited to the exemplary embodiment described above, and various design changes may be made thereto without departing from the scope of the present disclosure. Moreover, one aspect of the present disclosure allows various modifications within the scope of the claims, and exemplary embodiments obtained by suitably combining the disclosed technical means from different exemplary embodiments are also encompassed within the technical scope of the present disclosure. Furthermore, components disclosed in each of the above exemplary embodiments and modifications, including configurations where components with similar effects are replaced, are also encompassed.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A system design device that receives requirements of a system as input and outputs a concrete configuration of the system, the system design device comprising:
at least one memory configured to store instructions; and
at least one processor configured to execute the instructions to:
generate, by repeatedly applying to the requirements a concretization means that converts an abstract component included in the system into a concrete configuration, a tree structure in which the requirements serve as a root node and a configuration plan of the system concretizing the abstract component serves as a leaf node, perform a search by selecting the configuration plan with a higher evaluation value in the tree structure generated, and output the configuration plan in which all components are concretized as a concrete configuration; and
calculate an evaluation value of the configuration plan by considering an evaluation value of a logical configuration plan of the system included in the configuration plan that makes up the tree structure, and an evaluation value of a physical configuration plan of a device requiring physical arrangement included in the configuration plan.

2. The system design device according to claim 1, wherein the at least one processor is further configured to execute the instructions to:
extract devices requiring physical arrangement from the configuration plan, and generate a distance constraint topology expressing constraints between the devices.

3. The system design device according to claim 1, wherein the at least one processor is further configured to execute the instructions to:
generate an arrangeable region for the device for which an arrangement location is undetermined, based on the constraint between the device for which an arrangement location is determined and the device for which an arrangement location is undetermined, among the constraints between the devices requiring physical arrangement.

4. The system design device according to claim 3, wherein the at least one processor is further configured to execute the instructions to:
calculate an evaluation value for the physical configuration plan based on the size of the arrangeable region of the device for which an arrangement location is undetermined, and further calculate an evaluation value for the logical configuration plan by means of a predetermined method to calculate the evaluation value of the configuration plan.

5. The system design device according to claim 4, wherein the at least one processor is further configured to execute the instructions to:
determine an arrangement of the device for which arrangement is undetermined based on the device requiring the physical arrangement included in the concrete configuration that is output and the arrangeable region, and output a concrete configuration including the arrangement of the device.

6. The system design device according to claim 1, wherein the at least one memory is configured to store configuration components of the system, type information of a relationship between the configuration components, and the concretization means that converts abstract components included in the requirements into a concrete configuration.

7. A system design method for receiving requirements of a system as input and outputting a concrete configuration of the system, the system design method comprising:
generating, by repeatedly applying to the requirements a concretization means that converts an abstract component included in the system into a concrete configuration, a tree structure in which the requirements serve as a root node and a configuration plan of the system concretizing the abstract component serves as a leaf node; performing a search by selecting the configuration plan with a higher evaluation value in the tree structure generated; and outputting the configuration plan in which all components are concretized as a concrete configuration,
wherein
in the outputting, an evaluation value of the configuration plan is calculated by considering an evaluation value of a logical configuration plan of the system included in the configuration plan that makes up the tree structure, and an evaluation value of a physical configuration plan of a device requiring physical arrangement included in the configuration plan.

8. A non-transitory storage medium that stores a program that causes a computer to execute processes for a system design method for receiving requirements of a system as input and outputting a concrete configuration of the system, the processes comprising:
generating, by repeatedly applying to the requirements a concretization means that converts an abstract component included in the system into a concrete configuration, a tree structure in which the requirements serve as a root node and a configuration plan of the system concretizing the abstract component serves as a leaf node; performing a search by selecting the configuration plan with a higher evaluation value in the tree structure generated; and outputting the configuration plan in which all components are concretized as a concrete configuration,
wherein
in the outputting, an evaluation value of the configuration plan is calculated by considering an evaluation value of a logical configuration plan of the system included in the configuration plan that makes up the tree structure, and an evaluation value of a physical configuration plan of a device requiring physical arrangement included in the configuration plan.
